(19) United States
(12) Patent Application Publication
(10) Pub. No.: US 2026/0296347 A1
(43) Pub. Date: Oct. 1, 2026

(54) LID FOR VEHICLE

(71) Applicant: MORIROKU CO., LTD., Tokyo (JP)

(72) Inventor: Tomohiro Yoshino, Tokyo (JP)

(21) Appl. No.: 19/559,139

(22) Filed: Mar. 6, 2026

(30) Foreign Application Priority Data
Mar. 26, 2025 (JP) 2025-052096

(51) Int. Cl. B60R 19/02; B60R 13/04

(52) U.S. Cl. CPC B60R 19/023; B60R 13/04

(57) ABSTRACT

A lid includes a supported portion provided on a back surface of a main body, the supported portion being supported by a base portion formed at an edge of an opening of a base and serving as a fulcrum when the main body swings; and a lock that is elastically deformable and lockable to the base. A locking main body of the lock protrudes along a swing axis of the main body swings.

### FIELD OF THE INVENTION

The present invention relates to a lid for a vehicle that swings to disengage.

### BACKGROUND

An opening is formed in a part of a base of a four-wheeled vehicle, such as a bumper or a door lower, so as to allow access to the interior of the base. A lid that is detachably attachable is provided on the opening. A conventional technique relating to such a lid is disclosed in Japanese Unexamined Patent Publication No. 2011-168175.

The lid disclosed in this publication includes a main body having a plate shape that is formed along the shape of an opening. The main body is set to be supported by a base portion formed at a edge of the opening of a base and to swing to disengage from the opening when an end thereof is pressed.

### SUMMARY

When the opening is formed at a corner of the base, the shape of the lid also has a bent shape having a corner. When an end of the lid is pressed to remove the lid having a bent shape from the opening, a lock of the lid is pressed to further lock to a locking counterpart, thereby making it difficult for the lid to disengage from the opening, which leaves room for improvement.

An object of the invention is to provide a lid for a vehicle that has a bent shape and is easy to remove.

According to the present disclosure, there is provided a lid for a vehicle, the lid being made of resin and detachably attachable to an opening formed in a base includes: a main body that is formed in a bent shape along a shape of the opening and that swings to disengage from the opening; a supported portion provided on a back surface of the main body, the supported portion being supported by a base portion formed at an edge of the opening of the base and serving as a fulcrum when the main body swings; an operating portion provided on a design surface of the main body and configured to be pressed such that the main body swings to disengage from the opening; and a lock provided on the back surface of the main body and being elastically deformable and lockable to the base. The lock includes a locking main body protruding so as to be lockable to the base. The locking main body protrudes along an axis when the main body swings.

Furthermore, according to the present disclosure, there is provided a lid for a vehicle, the lid being made of resin and detachably attachable to an opening formed in a base includes: a main body that is formed in a bent shape along a shape of the opening and that swings to disengage from the opening; a supported portion provided on a back surface of the main body, the supported portion being supported by a base portion formed at an edge of the opening of the base and serving as a fulcrum when the main body swings; and a lock provided on the back surface of the main body and being elastically deformable and lockable to the base. The main body includes an operating portion configured such that the main body swings to disengage from the opening. The lock includes a locking main body protruding so as to be lockable to the base. The locking main body protrudes so as to approach an axis when the main body swings.

The invention can provide the lid for a vehicle that has a bent shape and is easy to remove.

### BRIEF DESCRIPTION OF THE DRAWINGS

FIG. 1 is a view for explaining a lid of a first embodiment that is detachably attachable to an opening of a base;

FIG. 2 is a view for explaining the lid attached to the base, as viewed from the back side of the base;

FIG. 3 is a perspective view of the lid of the first embodiment;

FIG. 4 is a view for explaining a manner in which the lid attached to the base is removed;

FIG. 5 is a view for explaining a lock as viewed along arrow 5 in FIG. 2;

FIG. 6 is a cross-sectional view taken along line 6-6 in FIG. 5;

FIG. 7 is a view for explaining a lid of a second embodiment;

FIG. 8 is a perspective view of a lid of a third embodiment; and

FIG. 9 is a view for explaining removal of a lid according to a conventional technique.

### DETAILED DESCRIPTION

Embodiments will be described with reference to the accompanying drawings. The embodiments described herein are not intended to limit the invention. Furthermore, the elements constituting the respective embodiments can be combined with each other as appropriate. In addition, redundant descriptions of members or portions that perform the same functions are omitted or simplified as appropriate.

In addition, in the drawings, Fr, Rr, Le, Ri, Up, and Dn denote front, rear, left, right, top or upward, and bottom or downward, respectively. These directions are used for convenience of description, and do not limit the orientation of a lid of the invention when in use.

### First Embodiment

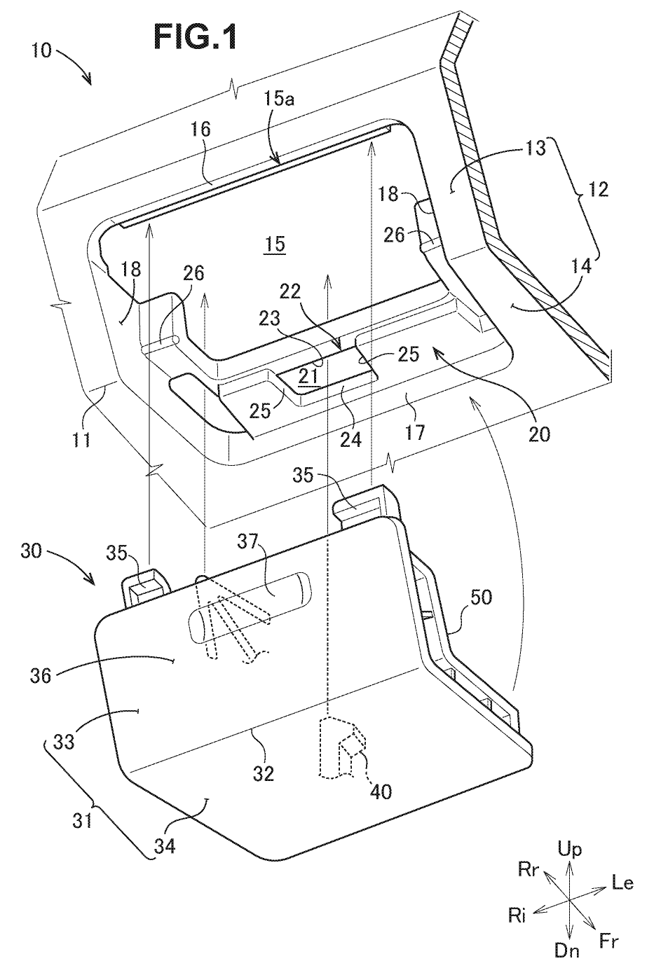

Referring to FIG. 1, a base 10 is an elongated door lower located at a lower portion of a door panel of a four-wheeled vehicle. The base 10 is not limited to a door lower, and may be any member or portion of a four-wheeled vehicle, such as a bumper. The base 10 may be a member or a portion in the vehicle interior. The base 10 has a bent shape including a corner 11. A design surface 12 of the base 10 includes a first design surface 13 on one side with respect to the corner 11 as a boundary, and a second design surface 14.

An opening 15 is formed in the base 10 at a position including the corner 11 of the base 10, that is, extending from the first design surface 13 to the second design surface 14. The shape of the opening 15 or the position where the opening 15 is formed can also be changed as appropriate. The opening 15 may be, for example, a hole that is round in a plan view.

An edge 15a of the opening 15 extends along a direction in which the corner 11 extends, and includes a first lateral edge 16 on the first design surface 13 side; a second lateral edge 17 on the second design surface 14 side; and two vertical edges 18 and 18, each having a bent shape including the corner 11. A protrusion 20 protrudes from the second lateral edge 17 and the two vertical edges 18 and 18.

A lid 30 made of resin (a lid 30 for a vehicle) is detachably attachable to the opening 15. The lid 30 is formed along the shape of the opening 15, and includes a main body 31 capable of closing the opening 15.

The main body 31 has a bent shape having a corner 32 (a shape formed by bending a plate-shaped member). With the corner 32 serving as a boundary, one side (the first design surface 13 side of the base 10) is defined as the first main body 33, and the side opposite to the first main body 33 (the second design surface 14 side of the base 10) is defined as the second main body 34.

Referring to FIG. 1, the pressed portion 37 that is slightly recessed so as to be pressed when the lid 30 is removed is formed on a design surface 36 of the first main body 33.

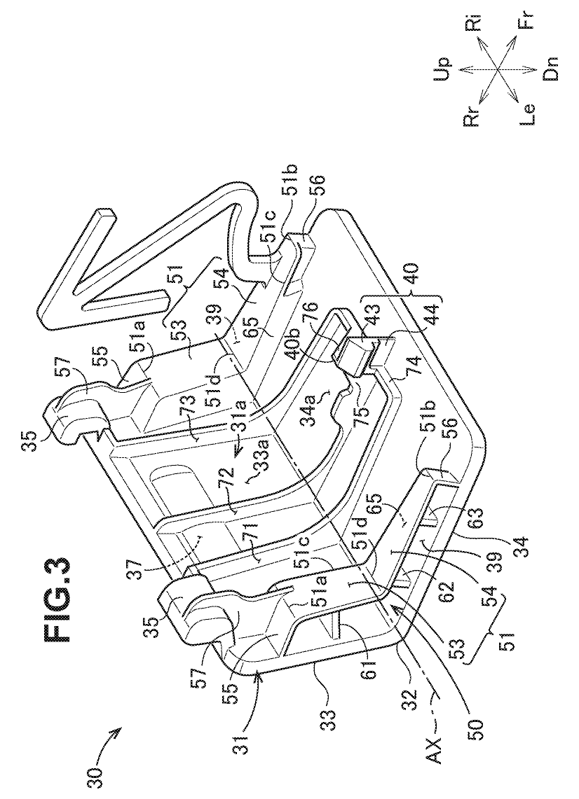

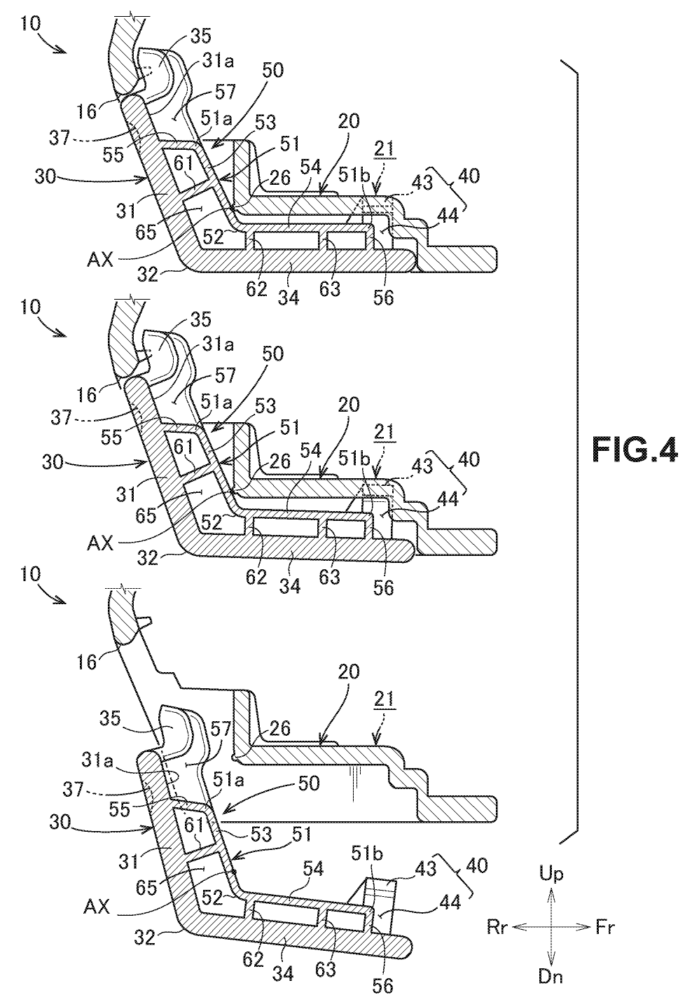

Referring to FIG. 3 and FIG. 4, when the pressed portion 37 is pressed, the lid 30 is supported by the base 10, and swings about an axis AX to disengage from the base 10.

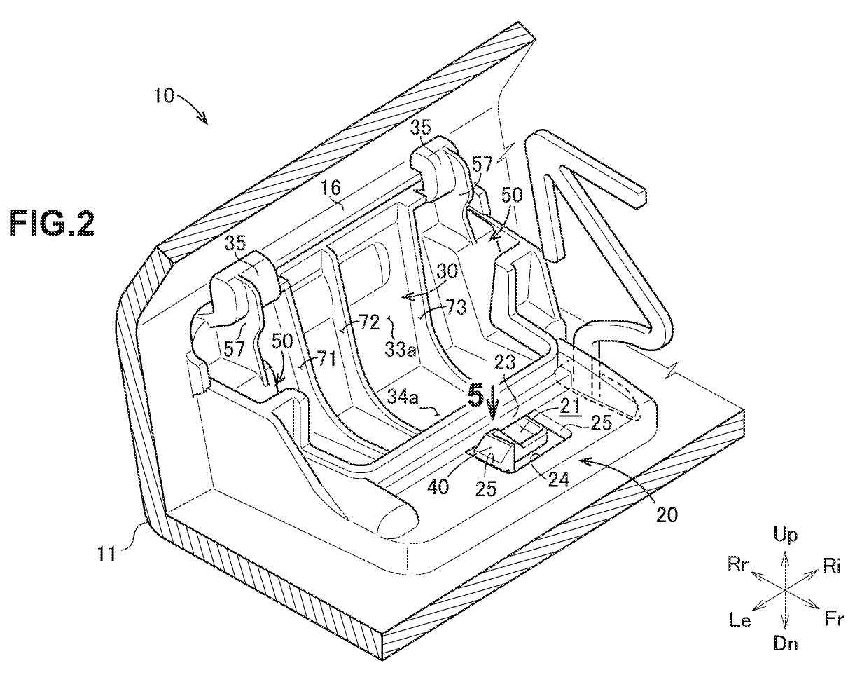

Referring to FIG. 1 and FIG. 2, the first main body 33 includes two hooks 35 capable of being hooked onto the ends on both sides of the first lateral edge 16 of the opening 15 when the lid 30 is attached to the base 10. The hooks 35 are provided on one of the first main body 33 and the second main body 34 of the lid 30, the one on which the pressed portion 37 is formed. The number of the hooks 35 may be one. The hooks 35 do not elastically deform unlike a lock 40 which will be described later. The hooks 35 each have a substantially U-shaped hook configuration that opens toward the edge 15a (and may also be regarded as fitting portions that fit into the edge 15a of the opening 15). When a pressed portion 37 is pressed, the hooks 35 move in a direction to disengage from the edge 15a.

When the lid 30 is attached to the base 10, first, the hooks 35 are hooked onto the first lateral edge 16. Next, the lid 30 is swung about the hooks 35 serving as pivot points. When the lock 40 provided on a back surface 34a of the second main body 34 is locked to the base 10, the lid 30 is attached to the base 10. The lock 40 is elastically deformable and lockable, and is a so-called snap fit. The lock 40 is provided on one of the first main body 33 and the second main body 34 of the lid 30, the one on which the pressed portion 37 and the hooks 35 are not provided (the one opposite to these portions).

A locking hole 21 (locked portion) to which the lock 40 is lockable is formed in the protrusion 20 of the base 10. The locking hole 21 is a rectangular through-hole having a longitudinal direction along the direction in which the corner 11 extends. An edge 22 of the locking hole 21 includes a first lateral edge 23, a second lateral edge 24, and two vertical edges 25. The locked portion, which is a counterpart to which the lock 40 locks, and may be any part of the base 10, and is not limited to the locking hole 21, but may be a part of an edge of the base 10.

Referring to FIG. 1 and FIG. 4, the protrusion 20 is provided with two base portions 26 that support the main body 31 when the main body 31 swings. The base portions 26 each have a columnar shape having a central axis along a direction in which the axis AX extends, and are formed so as to come into line contact with supported portions 50 which will be described below. The shape of the base portions 26 can be changed as appropriate.

Referring to FIG. 3 and FIG. 4, two supported portions 50 that are supported by the base portions 26 of the base 10 and serve as fulcrums when the main body 31 swings are provided on a back surface 31a of the main body 31. The supported portions 50 are provided at side portions 39 on both sides (left and right sides) of the main body 31 with respect to the direction in which the axis AX of swing extends.

The supported portion 50 include receiving portion 51 capable of coming into contact with the base portion 26 and receiving the base portion 26 when the lid 30 is removed. the receiving portions 51 may be configured to come into contact with the corresponding base portion 26 only when the lid 30 is removed.

The receiving portion 51 has an elongated plate shape, and has a bent shape including a corner 51d. The receiving portion 51 includes a first receiving portion 53 extending along the first main body 33, and a second receiving portion 54 extending along the second main body 34.

A first end 51a on one side of the receiving portion 51 is supported by a first support 55 having a rib shape. The first support 55 is provided on a back surface 33a of the first main body 33. The first support 55 and the hook 35 are continuous with each other via a connecting portion 57 having a rib shape.

A second end 51b opposite to the first end 51a is supported by a second support 56 having a rib shape. The second support 56 is provided on the back surface 34a of the second main body 34.

Referring to FIG. 3 and FIG. 4, three intermediate supports 61, 62, and 63, each having a rib shape and supporting the receiving portion 51, are provided between the first support 55 and the second support 56. The intermediate support 61 is provided on the back surface 33a of the first main body 33. The intermediate supports 62 and 63 are provided on the back surface 34a of the second main body 34. The number of the intermediate supports 61, 62, and 63 may be one. The intermediate supports 61, 62, and 63 may not be provided. The first support 55, the second support 56, and the intermediate supports 61, 62, and 63 extend in a direction along the axis AX.

With respect to the direction along the axis AX, a direction toward the center of the main body 31 is defined as the inner side, and a direction away from the center of the main body 31 is defined as the outer side. An edge 51c on the inner side of the receiving portion 51 is supported by a side wall 65 having a rib shape and being provided extending from the back surface 33a of the first main body 33 to the back surface 34a of the second main body 34. The side wall 65 may not be provided.

Three ribs 71, 72, and 73 orthogonal to the axis AX are provided on the back surface 31a of the main body 31. Each of the ribs 71, 72, and 73 is provided extending from the back surface 33a of the first main body 33 to the back surface 34a of the second main body 34. A connecting rib 74 that is continuous with an end of each of the ribs 71, 72, and 73 is provided on the back surface 34a of the second main body 34. The connecting rib 74 extends along the axis AX.

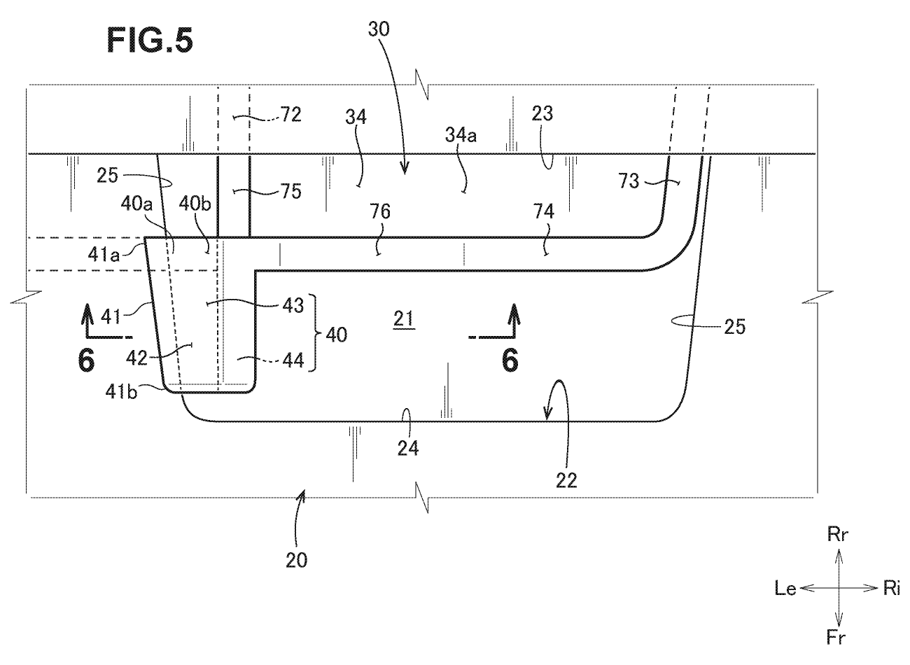

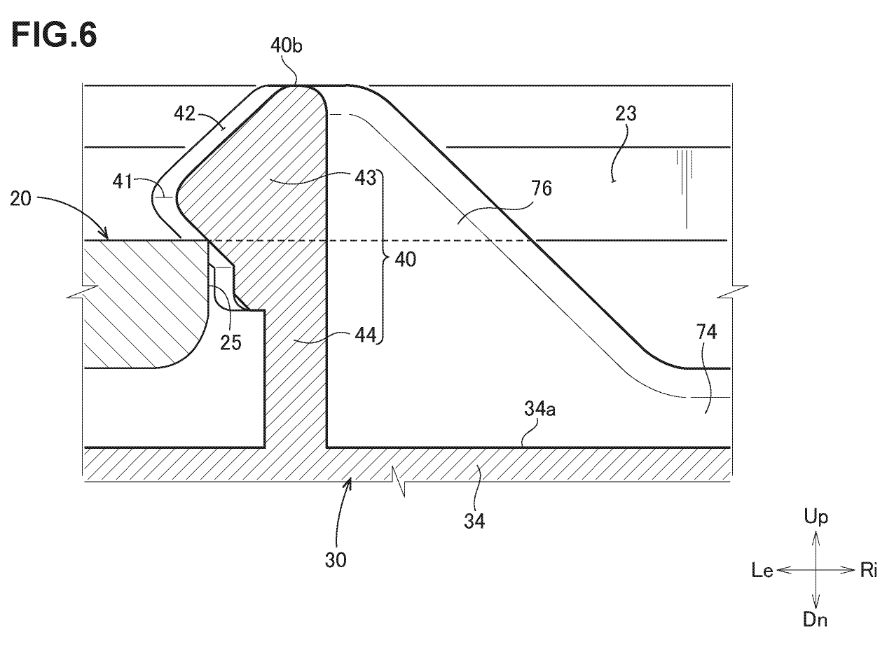

Referring to FIG. 5 and FIG. 6, the lock 40 includes a locking main body 43 that protrudes toward the vertical edge 25 (a locking counterpart) of the locking hole 21 and that locks to the vertical edge 25. The locking main body 43 has a sliding surface 42 that slides against the vertical edge 25 of the locking hole 21 when the lid 30 is attached and detached (see FIG. 1 and FIG. 4). A tip 41 of the sliding surface 42 may also be regarded as the tip of the locking main body 43 in a protruding direction.

Referring to FIG. 5, with the tip 41 of the sliding surface 42 facing the back surface 34a of the second main body 34 of the lid 30, the tip 41 is inclined with respect to a direction orthogonal to the axis AX (see FIG. 3) (a front-rear direction). A direction toward the axis AX is defined as a proximal side, and a direction away from the axis AX is defined as a distal side. A proximal end 41a of the tip 41 is located closer to the protruding side (left) of the locking main body 43 than a distal end 41b of the tip 41. The tip 41 may extend along the direction orthogonal to the axis AX.

Similarly to the tip 41 of the sliding surface 42, the vertical edge 25 of the locking hole 21 is inclined with respect to the direction orthogonal to the axis AX (see FIG. 3) (the front-rear direction).

The locking main body 43 is supported by a locking support 44 having a rib shape and extending from the back surface 34a of the second main body 34. The locking support 44 extends in the direction orthogonal to the axis AX. That is, the lock 40 is set so as to flex in the direction along the axis AX.

Referring to FIG. 3 and FIG. 5, the locking support 44 is located on the extension of the rib 72. The proximal end 40a of the lock 40 is continuous with the rib 72. The rib 72 includes an inclined portion 75 extending obliquely toward a top 40b of the proximal end 40a of the locking main body 43. The rib that is continuous with the lock 40 is not limited to the rib 72, and may be, for example, the rib 71 or the rib 73.

The proximal end 40a of the lock 40 is continuous with the connecting rib 74 on the side opposite to the protruding direction of the locking main body 43 (on the right side). The connecting rib 74 includes an inclined portion 76 extending obliquely toward the top 40b of the proximal end 40a of the locking main body 43.

Referring to FIG. 1, FIG. 4, and FIG. 5, when the lid 30 is attached to the base 10, among portions of the lock 40, the proximal end 40a first comes into contact with the vertical edge 25, thereby increasing a load. Since the proximal end 40a of the lock 40 is continuous with the rib 72 (the inclined portion 75) and the connecting rib 74, the proximal side of the lock 40 has high rigidity and is suitable for such a locking structure. The lock 40 may also be regarded as being set such that the proximal side thereof is less susceptible to elastic deformation. For example, only a portion on the proximal side of the locking support 44 may be made thicker. The lock 40 may be separated from both the rib 72 (the inclined portion 75) and the connecting rib 74. The lock 40 may be symmetrical between the proximal side and the distal side without bias in terms of ease of elastic deformation or rigidity.

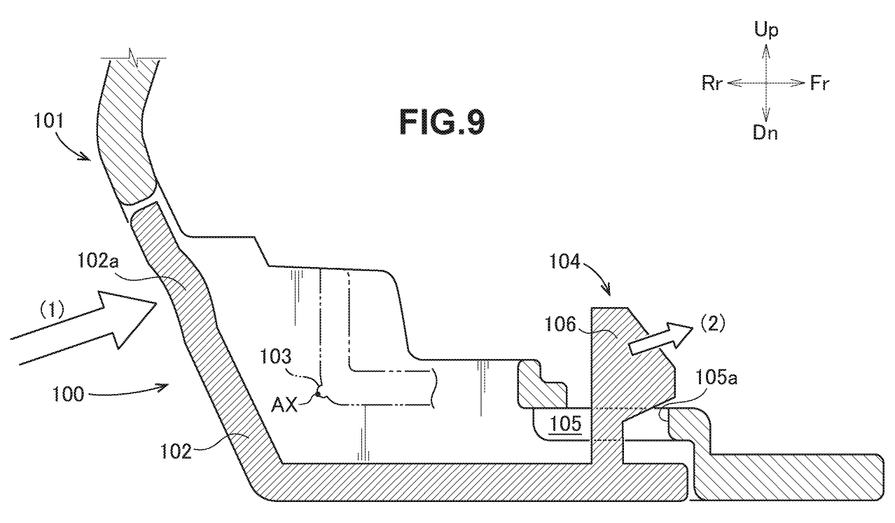

Referring to FIG. 9, in a conventional technique, a lid 100 that is detachably attachable to an opening of a base 101 will be described. as indicated by arrow (1), when an end 102aof a main body 102 is pressed, the lid 100 is configured to be supported by a base portion 103 of the base 101 and to swing about the axis AX to disengage from the base 101. However, as indicated by arrow (2), a locking main body 106 of a lock 104 protrudes in a direction away from the axis AX. Therefore, when the end 102a of the main body 102 is pressed, the locking amount of the lock 104 with respect to an edge 105a of a locking hole 105 increases, so that it is difficult for the lid 100 to disengage.

Referring to FIG. 3 and FIG. 4, according to a first aspect, the lid 30 for a vehicle, the lid 30 being made of resin and detachably attachable to the opening 15 formed in the base 10 includes: the main body 31 that is formed in a bent shape along the shape of the opening 15 and that swings to disengage from the opening 15; the supported portion 50 provided on the back surface 31a of the main body 31, the supported portion 50 being supported by the base portion 26 formed at the edge 15a of the opening 15 of the base 10 and serving as a fulcrum when the main body 31 swings; the operating portion 37 provided on the design surface 36 of the main body 31 and configured to be pressed such that the main body 31 swings to disengage from the opening 15; and the lock 40 provided on the back surface 31a of the main body 31 and being elastically deformable and lockable to the base 10. The lock 40 includes the locking main body 43 protruding so as to be lockable to the base 10. The locking main body 43 protrudes along a swing axis AX of the main body 31.

Since the locking amount of the locking main body 43 does not increase even when the operating portion 37 (the pressed portion 37) of the main body 31 is pressed, the locking main body 43 does not hinder the removal of the lid 30. The lid 30 for a vehicle that has a bent shape and is easy to remove can be provided.

### Second Embodiment

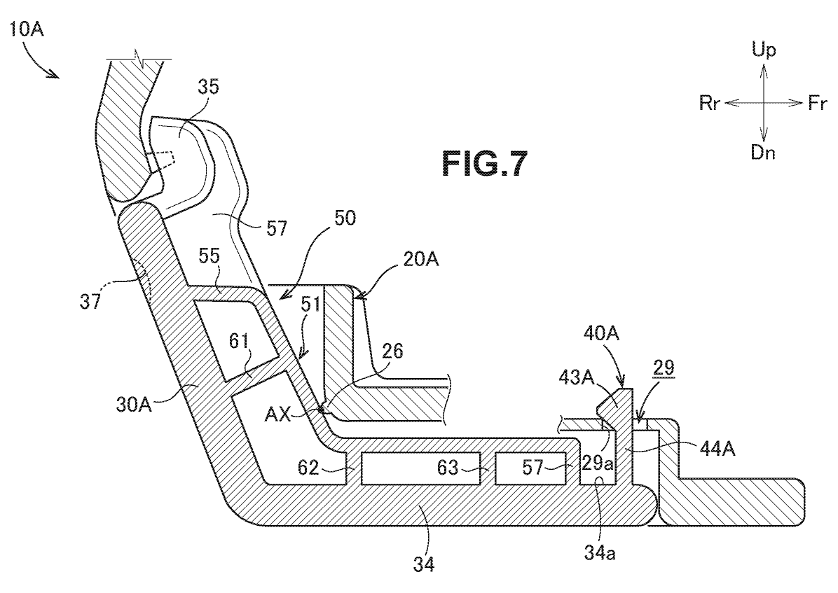

Referring to FIG. 7, a lid 30A of a second embodiment includes a lock 40A that is lockable to a locking hole 29 of a base 10A. The lock 40A is an elastically deformable snap fit. A direction in which elastic deformation occurs is a direction orthogonal to the axis AX. The lock 40A includes locking main body 43A that protrudes in a direction toward the axis AX (rearward) and that locks to a lateral edge 29a of the locking hole 29. The locking main body 43A extends from the back surface 34a of the second main body 34, and is supported by a locking support 44A having a rib shape.

According to a second aspect, the lid 30A for a vehicle , the lid 30A being made of resin and detachably attachable to the opening 15 formed in the base 10A includes: the main body 31 that is formed in a bent shape along the shape of the opening 15 and that swings to disengage from the opening 15; the supported portion 50 provided on the back surface 31a of the main body 31, the supported portion 50 being supported by the base portion 26 formed at the edge 15a of the opening 15 of the base 10A and serving as a fulcrum when the main body 31 swings; the operating portion 37 provided on the design surface 36 of the main body 31 and configured to be pressed such that the main body 31 swings to disengage from the opening 15; and the lock 40A provided on the back surface 31a of the main body 31 and being elastically deformable and lockable to the base 10A. The lock 40A includes the locking main body 43A protruding so as to be lockable to the base 10A. The locking main body 43A protrudes so as to approach a swing axis AX of the main body 31.

When the operating portion 37 (the pressed portion 37) of the main body 31 is pressed, the locking amount of the locking main body 43A decreases. The lid 30A for a vehicle that has a bent shape and is easy to remove can be provided.

According to a third aspect, in the lid 30 according to the first or second aspect, the hook 35 that is hooked onto the edge 15a of the opening 15 without being elastically deformed when the lid 30 is attached is provided on the back surface 34a of the main body 31 on the side opposite to the lock 40. The operating portion 37 is provided opposite to the lock 40.

When the operating portion 37 is pressed, the hooks 35 move in a direction to disengage from the edge 15a.

### Third Embodiment

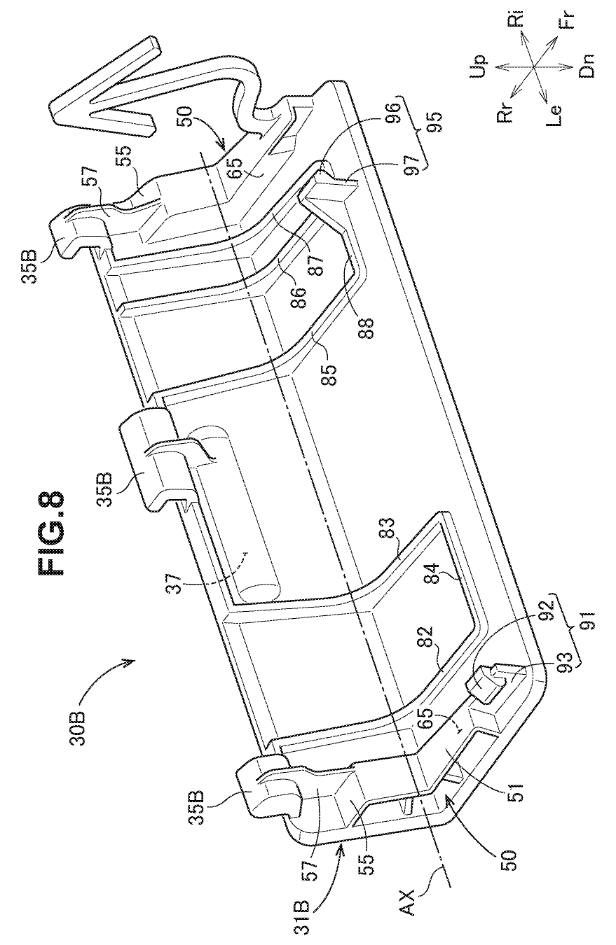

Referring to FIG. 8, a lid 30B of a third embodiment includes a main body 31B, three hooks 35B, two supported portions 50, two connecting portions 57, a first lock 91, and a second lock 95.

The main body 31B is provided with ribs 82 and 83, a connecting rib 84 that connects ends of the ribs 82 and 83, ribs 85, 86, and 87, and a connecting rib 88 that connects ends of the ribs 85, 86, and 87. A second locking support 97 is continuous with the rib 86 and the connecting rib 88. A first locking support 93 is continuous with the side wall 65.

A first locking main body 92 protrudes leftward. A second locking main body 96 protrudes rightward. The first locking main body 92 and the second locking main body 96 may also be regarded as protruding in opposite directions.

The protruding directions of the first locking main body 92 and the second locking main body 96 may be set along the axis AX. For example, both the first locking main body 92 and the second locking main body 96 may protrude rightward, or both may protrude leftward. Furthermore, the first locking main body 92 and the second locking main body 96 may protrude so as to face each other.

Since the locking amounts of the first locking main body 92 and the second locking main body 96 do not increase even when an operating portion 37 (the pressed portion 37) of the main body 31B is pressed, the first locking main body 92 and the second locking main body 96 do not hinder the removal of the lid 30B. The lid 30B for a vehicle that has a bent shape and is easy to remove can be provided.

In addition, the lid 30 for a vehicle, the lid 30 being made of resin and detachably attachable to the opening 15 formed in the base 10 includes: the main body 31 that is formed along the shape of the opening 15 and that swings to disengage from the opening 15 when the operating portion (the pressed portion 37) is pressed; and the supported portion 50 provided on the back surface 31a of the main body 31, the supported portion 50 being supported by the base portion 26 formed at the edge 15a of the opening 15 of the base 10 and serving as a fulcrum when the main body 31 swings. The supported portion 50 includes the first support 55 having a rib shape and the second support 56 having a rib shape that are provided on the back surface 31a of the main body 31, and the receiving portion 51 having a plate shape, the receiving portion 51 being supported by the first support 55 and the second support 56 and capable of receiving the base portion 26 when the main body 31 swings.

In the above-described structure of the supported portion 50, thin portions such as rib-shaped portions or plate-shaped portions are combined and joined to the main body, thereby suppressing appearance defects (sink marks) on the design surface while achieving a predetermined rigidity. Furthermore, since the receiving portion 51 having a plate shape has a predetermined width (in a left-right direction), the area that receives the supports is larger compared to a rib having a narrow width, so that the load can be distributed and quality degradation (an occurrence of rib crushing and play) when attachment and detachment are repeatedly performed can be suppressed. The lid 30 having a support structure that is less likely to affect the design surface 31 can be provided.

In addition, in the lid 30, the main body 31 has a bent shape, and includes the first main body 33 on one side with respect to the corner 32 as a boundary, and the second main body 34 opposite to the first main body 33. The first support 55 of the supported portion 50 is provided on the first main body 33. The second support 56 of the supported portion 50 is provided on the second main body 34.

The receiving portion 51 of the supported portion 50 spans from the first main body 33 to the second main body 34. When the main body 31 has a bent shape, the rigidity of the main body 31 is also increased by the supported portion 50. Deformation during molding and product distortion when a load is applied during attachment and detachment can be suppressed.

In addition, in the lid 30, the receiving portion 51 includes a first receiving portion 53 extending along the first main body 33, and a second receiving portion 54 extending along the second main body 34.

The receiving portion 51 is formed to be recessed along the main body 31 having a bent shape. The lid 30 can be made compact, and the receiving portions 51 can achieve high rigidity while saving space.

In addition, the lid 30 further includes the hook 35 that is hooked onto the edge 15a of the opening 15 when the lid 30 is attached to the base 10. The hook 35 and the first support 55 of the supported portion 50 are continuous with each other via the connecting portion 57 having a rib shape.

The first support 55 is a portion to which a force is applied during disengagement of the lid 30, and it is preferable that the rigidity of the first support 55 is higher.

What is claimed is:

1. A lid for a vehicle, the lid being made of resin and detachably attachable to an opening formed in a base, comprising:
a main body that is formed in a bent shape along a shape of the opening and that swings to disengage from the opening;
a supported portion provided on a back surface of the main body, the supported portion being supported by a base portion formed at an edge of the opening of the base and serving as a fulcrum when the main body swings;
an operating portion provided on a design surface of the main body and configured to be pressed such that the main body swings to disengage from the opening; and
a lock provided on the back surface of the main body and being elastically deformable and lockable to the base,
wherein the lock includes a locking main body protruding so as to be lockable to the base, and
the locking main body protrudes along a swing axis of the main body.

2. A lid for a vehicle, the lid being made of resin and detachably attachable to an opening formed in a base, comprising:
a main body that is formed in a bent shape along a shape of the opening and that swings to disengage from the opening;
a supported portion provided on a back surface of the main body, the supported portion being supported by a base portion formed at an edge of the opening of the base and serving as a fulcrum when the main body swings; and
a lock provided on the back surface of the main body and being elastically deformable and lockable to the base,
wherein the main body includes an operating portion configured such that the main body swings to disengage from the opening,
the lock includes a locking main body protruding so as to be lockable to the base, and
the locking main body protrudes so as to approach a swing axis of the main body.

3. The lid for a vehicle according to claim 1,
wherein a hook that is hooked onto the edge of the opening without being elastically deformed when the lid for a vehicle is attached is provided on the back surface of the main body on a side opposite to the lock, and
the operating portion is provided opposite to the lock.

4. The lid for a vehicle according to claim 2,
wherein a hook that is hooked onto the edge of the opening without being elastically deformed when the lid for a vehicle is attached is provided on the back surface of the main body on a side opposite to the lock, and
the operating portion is provided opposite to the lock.
